(19) United States
(12) Patent Application Publication
(10) Pub. No.: US 2023/0125533 A1
(43) Pub. Date: Apr. 27, 2023

(54) SYSTEM AND METHOD FOR DYNAMICALLY ENHANCING A PRICING DATABASE BASED ON EXTERNAL INFORMATION

(71) Applicant: DATALEX (IRELAND) LTD, Dublin (IE)

(72) Inventor: Ryan ESTES, Dublin (IE)

(21) Appl. No.: 17/969,469

(22) Filed: Oct. 19, 2022

Related U.S. Application Data
(60) Provisional application No. 63/257,474, filed on Oct. 19, 2021.

(51) Int. Cl. G06Q 30/02

(52) U.S. Cl. CPC G06Q 30/0206; G06Q 30/0201

(57) ABSTRACT

A system and method for dynamically determining a price adjustment based on current external market conditions at the time of request for a price from an end user. The system leverages various Al models. The external market conditions can include: historical sales data, booking data for flights not flown, scheduling data, cluster data to identify similar flights, holidays, seasonality data, competitive pricing and schedule data, weather data, external event data, consumer loyalty data. Data is provided initially to train the models, typically for the previous one to three years, and then subsequently at regular intervals to achieve as near-real time processing as is needed.

### RELATED APPLICATION DATA

This application claims benefit of U.S. Provisional Application Ser. No. 63/257,474 filed on Oct. 19, 2021, the disclosure of which is incorporated herein by reference.

### BACKGROUND

Airline ticket pricing is, in recent years, mostly determined by automated algorithms. Before the 1970s, many countries had some form of regulated ticket pricing. The introduction of the Airline Deregulation Act in 1978 largely eliminated regulated ticket pricing in the U.S. This opened up flying to many more travelers (and airlines) and generally lowered fares. However, turmoil in the industry including bankruptcies, followed and was attributed, by many, to deregulation.

Airlines will seek to maximize profits made through ticket sales, of course. A ticket can be worth different amounts to different people, and pricing is about determining this value and maximizing profit. A system of “booking classes” (e.g., economy, premium economy, and business class) and are a series of letters that define the fare level paid are conventionally used to determine airfares. These level indicators are generally consistent, including: F for full-fare first class; J for full-fare business class; and Y for full-fare economy. Most airlines also have discount levels below full fare. For example, American Airlines represents a discount business class D, C, R, and I class. and United Airlines, business class uses J, C, D, Z, and P discount class codes.

Each airline uses its algorithms to set and change prices. Notwithstanding the automation of pricing algorithms, traditionally, airlines use “static” pricing algorithms. For example, an airline constructs its fares using different price points based on reservation booking designators (RBD) and then publishes them through ATPCO. Each price point is developed for a specific purpose. Namely, for a specific customer segment and demand scenario.

### SUMMARY OF THE INVENTION

The reliance on RBD is becoming more and more problematic as it limits the number of price points that the airline may use. Most airlines and their revenue management departments use tools to establish their pricing strategies. However, without fully understanding market conditions, competitive landscape and even more complex data which requires some sophisticated data analytics and machine learning capabilities, airlines are not able to effectively segment their customers as otherwise possible or capture opportunities in real-time across the revenue cycle.

Disclosed implementations provide a method and system for dynamically pricing products and services, such as airline fares, in real-time and based on current market conditions. This allows the seller, such as an airline, to maximize their revenues while offering competitive and fair pricing to their customers. The disclosed implementations can be adapted to work within current airline booking and fare publishing processes.

A first aspect of the invention is a system for creating a dynamic database of airfares, the system comprising: a data storage configured to store flight-related data including historical and future flight-related data; a price prediction module, including a regression-based model, configured to generate a price prediction for an optimum fare for a specific flight and booking class based on the flight related data; a demand forecast module, including a regression-based model, configured to predict expected demand for a specific flight and booking class based on the flight related data; a reasoning module, including fuzzy logic, configured to determine if the price prediction is reasonable based on a comparison between actual demand and the expected demand; an adjustment module configured to apply an adjustment to the price prediction, to obtain an optimum price, when the price prediction is not found to be reasonable; and an application programming interface (API) configured to communicate with one or more shopping engines to thereby provide enhanced pricing data to the shopping engines.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the appended drawings various illustrative implementations. It should be understood, however, that the invention is not limited to the precise arrangements and instrumentalities shown. In the drawings:

FIG. 1 is a block diagram of interactions between disclosed implementations of pricing systems and conventional airline shopping engines.

FIG. 2 is block diagram of a computing architecture in accordance with disclosed implementations.

FIG. 3 is a flow chart is a flow chart of a pricing optimization process in accordance with disclosed implementations.

FIG. 4 is a flowchart of a method of enhancing a pricing database in accordance with disclosed implementations.

### DETAILED DESCRIPTION

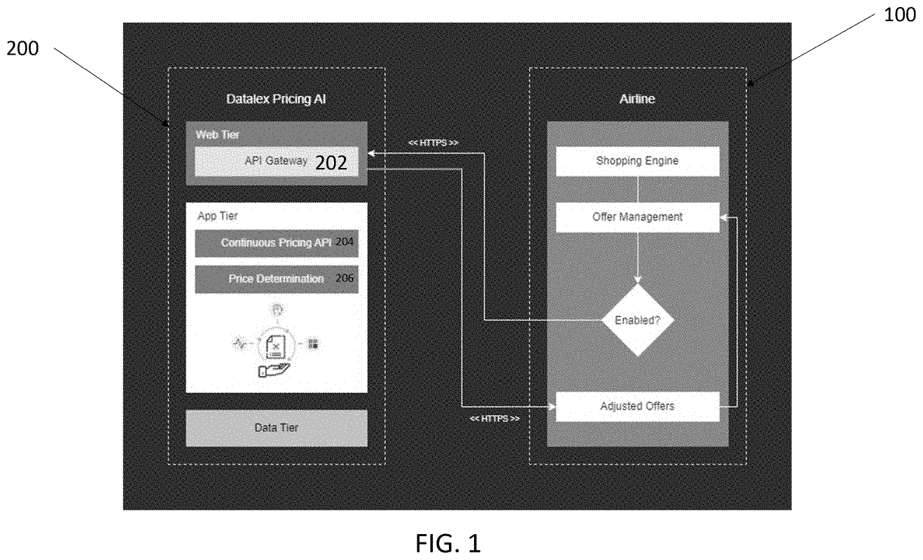

As show in FIG. 1, airline shopping engine 100 can generate an offer (i.e., fare price) in a conventional manner. If dynamic optimization is enabled, the offer can then be transmitted to dynamic pricing web API 202 of dynamic pricing engine 200, the list of priced offers will then be sent to continuous pricing API 204 of price determination engine 206, which will dynamically determine the optimal price based on current market conditions and return its recommendation, via API 202, to the Airline's Shopping Engine in the form of adjusted offers. Optimal prices can be returned by the API 202 in the form of price adjustments relative to the original price, a new price value, or in any other way that indicates and optimal price. Airline shopping engine 100 will then import the adjusted offers into their internal offer model and present them back to the end user. This process is described in more detail below. The process described above can be accomplished dynamically in response to a price inquiry from an end user of airline shopping engine 100.

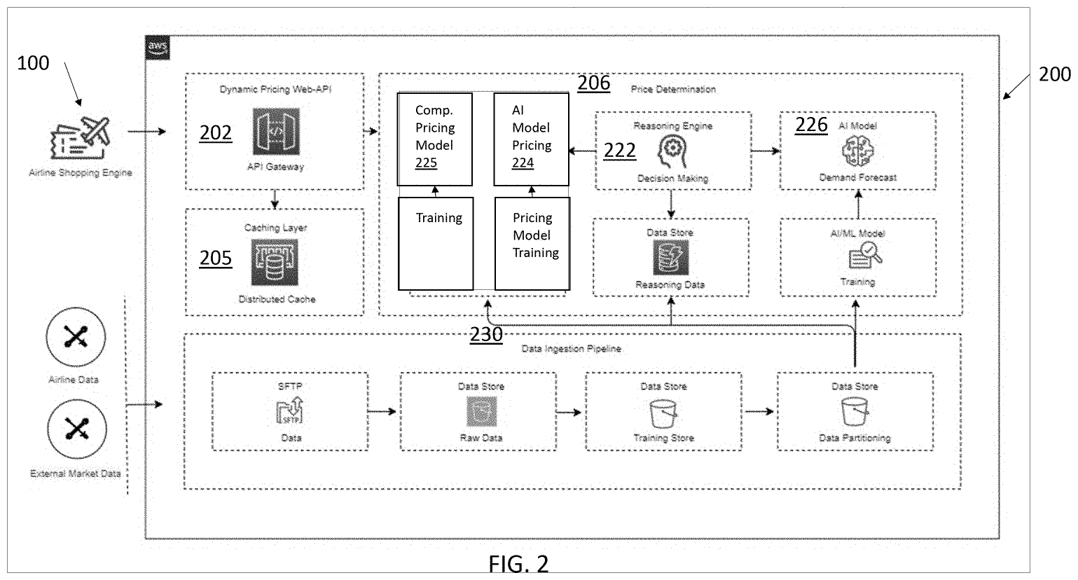

As shown in FIG. 1 and FIG. 2, dynamic pricing web API 202 (which can serve as a RESTful integration point) is used to interface a conventional airline shopping engine with the dynamic pricing system. As shown in FIG. 2, which illustrates system 200 of FIG. 1 in greater detail, distributed cache 205 is configured to provide fast access to dynamically priced offers, which can be cached for a configurable period of time based on both performance and cost considerations. Namely, the cost of running the system. In addition, it is advantageous to avoid price fluctuations between successive end user requests to avoid a negative impact to the user experience.

Price determination engine 206, determines the optimal price for a given flight offer. Cognitive logic 222 determines whether a price prediction suggested by price prediction model 224 is reasonable or not. By applying a chain of fuzzy logic to the outputs of the various AI models. For an example, the fuzzy logic system can receive the price prediction as well as d2d as inputs to determine whether the price point should move. It will then look at the forecasted demand vs. the actual demand to determine same. It continues this process for each Al model. Alternatively, instead of chained fuzzy logic a Fuzzy Cognitive Map (FCM), which applies an adjacency matrix and Kosko's Inference equation to determine inference all together. If a price prediction is considered unreasonable, the price prediction will be adjusted based on external factors at the time of the request. This is supported by fuzzy logic.

Fuzzy logic is based on the notion of relative membership grades and inspired by processes of human perception and cognition that are uncertain, imprecise, partially true or lacking in sharp boundaries. Fuzzy logic allows for the inclusion of vague human assessments in computing problems. Fuzzy Logic (FL) imitates the decision-making process that involves all intermediate possibilities between digital values YES and NO. The inventor of fuzzy logic, Lotfi Zadeh, observed that unlike computers, the decision-making process includes a range of possibilities between YES and NO.

A typical Fuzzy System Architecture has 4 main components:
PART 1: Fuzzification Module—Transforms the system inputs, which are crisp values, into fuzzy sets.
PART 2: Knowledge Base—Stores IF-THEN rules provided by experts.
PART 3: Inference Engine—Simulates human reasoning by making fuzzy inference on the inputs and IF-THEN rules.
PART 4: Defuzzification Module—It transforms the fuzzy set obtained by the inference engine into a crisp value.

Membership functions (MF) are used to quantify linguistic values. A membership function for a fuzzy set A on the universe of discourse X is defined as μ_{A}: X→[0,1]. Each element is mapped to a value between 0 and 1—referred to membership value or degree of membership. Graphically, the x-axis represents the universe of discourse. The y-axis represents the degrees of membership. Simple membership functions are used as complex functions do not add more precision to the output. The triangular membership function is most common among various other membership functions such as trapezoidal, singleton, and Gaussian.

While the type of MF does not play a crucial role in shaping how the model performs, the number of MFs has greater influence as it determines the computational time. Hence, the optimum model can be determined by varying the number/type of MFs for achieving best system performance. Table 1 below shows common membership functions for the fuzzification process.

TABLE 1
Common members lip functions for the fuzzification process.

| Membership Function | Equation |
|---|---|
| Triangular: | $f ( \text{x:} a , b , c ) = \{ \begin{matrix}0 , & x \leq a \\ \frac{x - a}{b - a} , & a \leq x \leq b \\ \frac{c - x}{c - b} , & b \leq x \leq c \\ 0 , & c \leq x\end{matrix}$ |
| | or more compactly, |
| | $f ( \text{x:} a , b , c ) = max ( min ( \frac{x - a}{b - a} , \frac{c - x}{c - b} , 0 )$ |
| Trapezoid-Shaped: | $f ( \text{x:} a , b , c , d ) = max ( min ( \frac{x - a}{b - a} , 1 , \frac{d - x}{d - b} , 0 )$ |
| Gaussian: | $f ( \text{x:} σ , c ) = {e}^{\frac{- {( x - c )}^{2}}{2 {σ}^{2}}}$ |

Price prediction model 224 is configured to generate a price prediction for an optimum fare for a specific flight and booking class based on the flight related data and includes a regression-based model which aims to predict the price given factors such as departure date, leg, transaction date and brand. The current algorithm is an XGBoost model which achieves a high degree of predictive accuracy. The training process is based on practice standards, but was enhanced to include training loss and validation loss curves. Such loss curves well known in training AI models. External data is used to create the AI models. Once the AI models are created/trained and deployed. Then they are used by price determination for querying.

These curves indicate any signs of underfitting, overfitting and generalisation errors during training. One of the most vital pieces of Data Science is Exploratory Data Analysis (EDA) which is done before any modelling can take place. The EDA provides the ability to profile, analyse and potentially discover any errors within the original dataset. The amount of data required is dependent on the predictive accuracy achieved.

Price prediction model 224 can be constructed using XGBoost, a decision-tree-based ensemble Machine Learning algorithm. Ensemble learning offers a systematic solution to combine the predictive power of multiple learners. Fundamentally, machine learning algorithms seek to learn relationships between inputs and outputs. Feature engineering is a component of this step. Feature engineering is the process of transforming raw data to provide the algorithms with the most predictive inputs possible. The algorithm is capable of pricing like revenue management based on the pricing patterns it learns. The algorithm is also capable of emphasizing other important features that may not have been considered by the airline thus improving their overall pricing strategies. Price predictions can be based on various data fields representing external data including: FARE_FAMILY, BOOKING_CLASS, PAX_TYPE, TRIP_TYPE, LEG_NUMBER, POS, LEG, HOLIDAY, SEASON, DEPARTURE_YEAR, DEPARTURE_MONTH, DEPARTURE_WEEK_OF_YEAR, DEPARTURE_DAY_OF_WEEK, DEPARTURE_HOUR, DEPARTURE_DAY, TRANSACTION_MONTH, TRANSACTION_WEEK_OF_YEAR, TRANSACTION_DAY_OF_WEEK, TRANSACTION_HOUR, TRANSACTION_DAY, ARRIVAL_HOUR, DAYS_TO_DEPARTURE, PHYSICAL_CAPACITY, FLIGHT_DISTANCE, and TOTAL_BOOKINGS, PROMO_FLAG.

Demand forecasting model 226 can be configured to predict expected demand for a specific flight and booking class based on the flight related databy accurately predicting the expected demand from a specified time, for example 330 days prior, to the day of departure. The algorithm can an XGBoost model which achieves a high degree of predictive accuracy. Demand forecasting model 226 can be part of a wider solution which considers a secondary “Price Prediction” model. With the average curve of a particular booking class, calculated using statistical methods in conjunction with the prediction from the demand per flight model, it is possible to split the forecast into different curves per booking class.

Pbc=PlfC<Dbc>t

Where Pbc is the predicted cumulative seat sold per booking class at time t, Plf is the predicted load factor from the demand per flight model at time t, C is the capacity of the flight and <Dbc>t is the average ratio of the booking class to the capacity from the historic data at time t. In addition, multiple models are used which consider that the cumulative seats sold at time t is a function which is dependent on the previous values of the same demand curve at time t−1. To account for this, we use a “snapshot model” approach where we would have multiple models take into account different values for cumulative seats sold in a particular period. As shown by data ingestion pipleline 230 of FIG. 2, the data needed for training the logic can be collected and stored in its raw format for archiving purposes. From there, the data is transformed and placed into the training store. Finally, the data is partitioned into different data sets for training the logic. Note that various other AI models, such as competitive pricing AI model 225 can be applied to process that various information disclosed herein.

The demand forecast can be based various data fields representing external data including: CARRIER, CABIN, DAYS_TO_DEPARTURE, PHYSICAL_CAPACITY, ORIGIN, DESTINATION, FLIGHT_DISTANCE, HOLIDAY, SEASON, DEPARTURE_YEAR, DEPARTURE_MONTH, DEPARTURE_DAY, DEPARTURE_DAY_OF_WEEK, DEPARTURE_WEEK_OF_YEAR, DEPARTURE_HOUR, TRANSACTION_YEAR, TRANSACTION_MONTH, TRANSACTION_DAY, TRANSACTION_DAY_OF_WEEK, TRANSACTION_WEEK_OF_YEAR, LEG, DAYS_SINCE_LAST_TRANSACTION, and NEAR_PAYDAY, LOAD_FACTOR_SHIFTED.

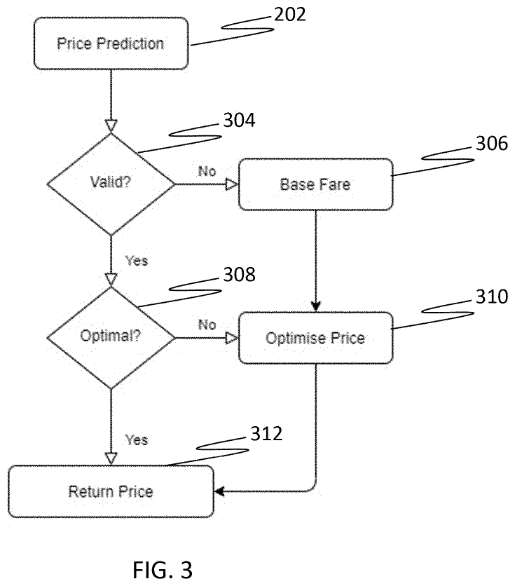

FIG. 3 illustrates a pricing optimization process accomplished by price determination engine 206. The optimization process considers various “what-if” scenarios to determine reasonableness and thus optimize price. Using statistical methods, it can be determined whether the price prediction is valid or not. If the price prediction is not valid, the predicted price is discarded and the original price is used. The optimization process then looks at the current market conditions, competitive landscape and other complex data needed to determine if the price is reasonable.

Data ingestion pipeline 230 is configured for ingesting, transforming and partitioning data for the purposes of training, testing and validating the models (logic) within the system. Examples of data used for training the models includes: historical sales data, booking data for flights not flown, scheduling data, cluster data to identify similar flights, holidays, seasonality data, competitive pricing and schedule data, weather data, external event data, consumer loyalty data. Data is provided initially to train the models typically for the previous one to three years (or more) and then subsequently at regular intervals to achieve as near-real time processing as is needed.

As shown in FIG. 3, the forecasted price is retrieved from the price prediction model at step 302. The prediction is then verified using statistical methods to determine whether it is valid or not and step 304. If the prediction is not valid, then the offer price determined by the airline is used as the price prediction (step 306). If the prediction is valid, the next step is to look at various market conditions (e.g., forecasted demand vs. actual demand, competitive pricing, etc . . . ) to determine whether the prediction is optimal for both the airline and the consumer, at step 308. If the prediction is determined not to be optimal, the offer will be re-priced, at step 310. At step 312, the optimal price is then returned to the airline shopping engine in the format of an adjustment relative to the original offer price. If, at step 208, the price is determined to be optimal, then the process proceeds directly to step 312. This is done for ease of integration on the side of the airline shopping engine. During fulfillment, the airline will need to notify the PSS of any price changes in the form of an adjustment (up or down).

An example data structure of a pricing request that can be posted to the optimization engine is set forth below.

{
“tripType”: “ROUNDTRIP”'
“pos”: “IE”,
“channel”: “INTERNET”,
“travelers”; [...],
“farefamily”: [...]
“flightOffers”: [...]
}

An example data structure of a response from the optimization engine is set forth below.

```
{
  “id”: 1,
  “price_adjustment_summary”: [
    {
      “adjustment_type”: “DISCOUNT”,
      “adjustment_amount”: 5.00,
      “adjustment_percentage”: 0,
      “use_percentage”: false,
      “origin_destination_price_ref”; 1,
      “traveler_ref”: [
            1,
            2
      ]
      “traveler_type”: “ADT”
    }
  ]
“external_ID”; “e8f7a8f8-4858-43fc-acef-e1568fd7fa58”
}
```

The id is the internal id of the adjusted offer, where “externalID” represents the external id determined by the calling client. The price adjustment summary represents the Al recommendation for a given offer. The adjustment type can be a discount or premium (mark-down or mark-up) from the original offer price. The airline can configure whether to represent the recommendations as flat values or percentages. If “use_percentage” is false the “adjustment_amount” is used. Otherwise “adjustment_percentage” is used. The airline also has the ability to configure limitations on how much a fare can be marked-up or marked-down.

Several implementations are specifically illustrated and/or described herein. However, it will be appreciated that modifications and variations are covered by the above teachings and within the scope of the appended claims without departing from the spirit and intended scope thereof. For example, while airline fares are discussed herein as examples, the systems and method discussed may be applied to other types of fares, tolls, fees, and/or prices. For example, cruse fares, hotel rooms or rental car fees. In another example, the systems and methods discussed herein may be used to price fares and/or ancillaries in bundles or in loyalty points. Specifically, a fare or upgrade may be priced in terms of frequent flier miles. Ancillaries may include baggage fees, rental cars, hotel stays, and/or the like.

In some implementations, additional competition logic is configured to generate the price such that price beats or matches the competitor's price. For example, the competition logic may generate a price as close as possible to the price predicted by the price prediction logic but less than the competitor's price. The competition logic optionally takes into account the number of legs in a trip, the time of a flight, customer loyalty (e.g., frequent flyer status), a channel through which the customer is booking the flight, and/or the like. The competition logic may assign a value to these factors. For example, the competition logic may consider that a particular customer prefers direct flights over multi leg flights or dislikes late night flights, and has been known to pay a premium fare for such differences. The premium assigned for specific characteristics may be specific to individual customers, classes of customers, sales channels, and for any other characteristic discussed herein.]

System 200 can include a competition module configured to generate a price based on competitor's prices, and the reasoning module can be configured to determine the price adjustment based on the competitor's prices. The data stored in the data storage can include at least one of historical date dependent flight sales data, flight schedules, cluster information indicating similar flights, and/or booking data.

As noted above, the reasoning engine logic uses fuzzy logic to determine if a price prediction is reasonable. For example, the reasoning logic may compare predictions received from the demand forecast logic to the actual demand to determine how “high” the actual demand is from the forecasted demand. The reasoning engine logic may also compare how “close” the purchase is to the day of departure and the like. Further, the reasoning engine logic can be configured to determine if the price prediction is reasonable based on “degrees of truth” e.g., ranging between the values 0 and 1. Fuzzy logic is an approach to computing based on “degrees of truth” rather than the usual “true or false” (1 or 0) Boolean logic on which the modern computer is based. The qualitative data can be defined using linguistic variables. Membership functions are constructed for each of the input and output variables. Fuzzy rules are applied to obtain a fuzzy output. Then a defuzzification process converts the fuzzified output into a single crisp value with respect to the fuzzy set. The crisp value represents the adjustment and the direction of the adjustment.

The reasoning engine logic can be configured to determine if the price prediction is reasonable based on a length of time before a departure date of the flight. For example, the predicted price received from the price prediction logic may be dependent on how many days the booking is being made prior to the scheduled departure of a flight. In another example, a price adjustment may be considered more certain or less certain, e.g., have a higher weighting function, as a function of how many days are remaining prior to the departure of a flight.

Further, the reasoning engine logic can be configured to determine if the price prediction is reasonable based on competitor's prices. In some implementations, the reasoning engine logic is responsive to changes in competitor's prices. For example, if a competitor raises their prices for a particular flight, then it might be assumed that that flight is near fully booked (demand is higher). Likewise, if a competitor lowers their prices, it might be assumed that a fight has fewer bookings than expected (demand is lower). The reasoning engine logic can also be configured to determine if the price prediction is reasonable based on weather predictions or current weather. For example, under weather conditions where flights may be cancelled, fares may be higher (because demand is higher).

The reasoning engine logic can be configured to determine if the price prediction is reasonable based on a flight cancellations. For example, fares may be raised based on the cancellation of competitor flights. In some implementations, the demand forecast model logic is further configured to estimate supply of seats on particular flights and/or particular origin/destination pairs. As such, both supply and demand may be predicted, and used by the reasoning engine logic to determine if the price prediction is reasonable. The reasoning engine logic can be configured to determine if the price prediction is reasonable based on market competition.

The reasoning engine logic can also be configured to determine if the price prediction is reasonable based on aircraft and crew availability. This can include positioning of aircraft and crew, the time required to recover from weather or other flight disruptions, such as labor strikes, pandemic, equipment breakdown, and the like. The reasoning logic can be further configured to determine if the price prediction is reasonable based on customer loyalty, e.g., how likely an end user would be to book with a competitor based on price changes (possibly considering frequent flyer programs benefits and membership.

The optimum fare may be the most profitable fare and/or a fare that fills an aircraft with the greatest revenue. In some implementations an optimum fare is a fare that beats a competitor's fare but is still profitable. In some implementations an optimum fare is a fare for a multi-leg trip. The expected demand may be predicted for any PAX classification, and/or any flight characteristics such as origin and destination, number of days to a departure, departure date, departure time, trip type (one-way, return, or multi-city), and/or any other flight characteristics discussed herein. For example, the data in the data storage can be data needed to identify a specific flight and booking class, seats sold, expected number of seats sold, seasonality and holiday information.

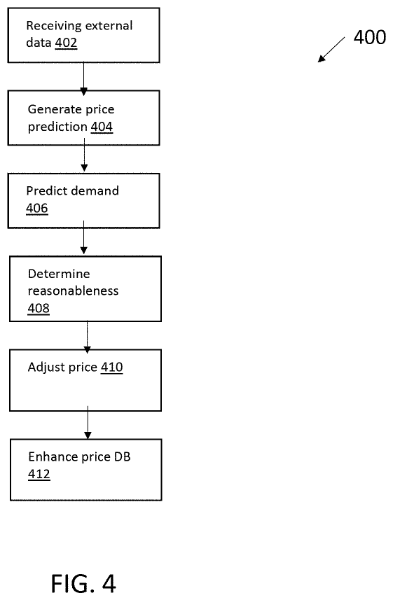

FIG. 4 illustrates price optimization and database enhancement process 400 in accordance with disclosed implementations. At step 402, flight-related data, including historical and future flight-related data, is received. at 404, a regression-based model is applied to generate a price prediction for an optimum fare for a specific flight and booking class based on the flight related data. At 405, a regression-based model is applied to predict expected demand for a specific flight and booking class based on the flight related data. At step 408, a fuzzy logic algorithm is applied to determine if the price prediction is reasonable based on a comparison between actual demand and the expected demand. At step 410, the price prediction is adjusted, to obtain an optimum price, when the price prediction is not found to be reasonable. At step 412, the optimum price is transmitted to one or more shopping engines to thereby provide enhanced pricing data to databases of the shopping engines.

Computing systems and/or logic referred to herein can comprise an integrated circuit, a microprocessor, a personal computer, a server, a distributed computing system, a communication device, a network device, or the like, and various combinations of the same. A computing system or logic may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), optical circuits, and/or other devices configured for storing analog or digital information, such as in a database. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The logic discussed herein may include hardware, firmware and/or software stored on a non-transient computer readable medium. This logic may be implemented in an electronic device to produce a special purpose computing system. The systems discussed herein optionally include a microprocessor configured to execute any combination of the logic discussed herein. The methods discussed herein optionally include execution of the logic by said microprocessor. The disclosed implementations are described as including various “modules”, “engines”, and “logic”, all of which refer to executable code and a computer hardware processor for executing the code to accomplish the described functionality. The Data Storage may be distributed throughout several computing devices.

It will be appreciated by those skilled in the art that changes could be made to the implementations described above without departing from the broad inventive concept thereof. It is understood, therefore, that this invention is not limited to the particular implementations disclosed, but it is intended to cover modifications within the spirit and scope of the present invention as defined by the appended claims.

What is claimed:

1. A system for creating a dynamic database of airfares, the system comprising:
a data storage configured to store flight-related data including historical and future flight-related data;
a price prediction module, including a regression-based model, configured to generate a price prediction for an optimum fare for a specific flight and booking class based on the flight related data;
a demand forecast module, including a regression-based model, configured to predict expected demand for a specific flight and booking class based on the flight related data;
a reasoning module, including fuzzy logic, configured to determine if the price prediction is reasonable based on a comparison between actual demand and the expected demand;
an adjustment module configured to apply an adjustment to the price prediction, to obtain an optimum price, when the price prediction is not found to be reasonable; and
an application programming interface (API) configured to communicate with one or more shopping engines to thereby provide enhanced pricing data to the shopping engines.

2. The system of claim 1, wherein the regression-based model of the price prediction module is trained based on relationships between price-influencing factors and historical successful prices.

3. The system of claim 1, wherein the price-influencing factors include at least two factors selected from base fare, point of sales, channels, fare families, origin & destinations, dates & times, number of stops, trip type, passenger PAX type, cabins, booking class, and/or days to departure.

4. The system of claim 1, wherein the regression-based model of the demand forecast module is trained based on flight scheduling and historical sales data.

5. The system of claim 1, wherein an optimum price adjustment is determined based on the optimum price and a current price and wherein the optimum price adjustment is communicated to an airline shopping engine of the one or more shopping engines through the API to allow the airline shopping engine to calculate a new price based on the optimum price adjustment and a current price used by the airline shopping engine.

6. The system of claim 1, further comprising a competition module configured to generate a price based on competitor's prices, and wherein the reasoning module is further configured to determine the price adjustment based on the competitor's prices.

7. The system of claim 1 wherein the data stored in the data storage includes at least one of historical date dependent flight sales data, flight schedules, cluster information indicating similar flights, and/or booking data.

8. The system of claim lwherein the reasoning module is configured to determine if the price prediction is reasonable based on degrees of truth.

9. The system of claim 1, wherein the reasoning module is further configured to determine if the price prediction is reasonable based on a length of time before a departure date of the flight.

10. The system of claim 1, wherein the reasoning module is further configured to determine if the price prediction is reasonable based on competitor's prices.

11. The system of claim 1, wherein the reasoning module is further configured to determine if the price prediction is reasonable based on weather predictions or current weather.

12. The system of claim 1, wherein the reasoning module is further configured to determine if the price prediction is reasonable based on a flight cancellations.

13. The system of claim 1, wherein the reasoning module is further configured to determine if the price prediction is reasonable based on market competition.

14. The system of claim 1, wherein the reasoning module is further configured to determine if the price prediction is reasonable based on aircraft and crew availability.

15. The system of claim 1, wherein the reasoning module is further configured to determine if the price prediction is reasonable based on customer loyalty.

16. A Method for creating a dynamic database of airfares, the method comprising:
receiving flight-related data including historical and future flight-related data;
applying a regression-based model to generate a price prediction for an optimum fare for a specific flight and booking class based on the flight related data;
applying a regression-based model to predict expected demand for a specific flight and booking class based on the flight related data;
applying a fuzzy logic algorithm to determine if the price prediction is reasonable based on a comparison between actual demand and the expected demand;
adjusting the price prediction, to obtain an optimum price, when the price prediction is not found to be reasonable; and
transmitting the optimum price to one or more shopping engines to thereby provide enhanced pricing data to databases of the shopping engines.

17. The method of claim 16, wherein the regression-based model applied for price prediction is trained based on relationships between price-influencing factors and historical successful prices.

18. The method of claim 16, wherein the price-influencing factors include at least two factors selected from base fare, point of sales, channels, fare families, origin & destinations, dates & times, number of stops, trip type, passenger PAX type, cabins, booking class, and/or days to departure.

19. The method of claim 16, wherein the regression-based model applied for expected demand forecast is trained based on flight scheduling and historical sales data.

20. The method of claim 16, wherein an optimum price adjustment is determined based on the optimum price and a current price and wherein the optimum price adjustment is communicated to an airline shopping engine of the one or more shopping engines through the API to allow the airline shopping engine to calculate a new price based on the optimum price adjustment and a current price used by the airline shopping engine.

21. The method of claim 16, further comprising a generating a price based on competitor's prices, and wherein the reasoning module is further configured to determine the price adjustment based on the competitor's prices.

22. The method of claim 16, wherein the data includes at least one of historical date dependent flight sales data, flight schedules, cluster information indicating similar flights, and/or booking data.

23. The system of claim 16, wherein the fuzzy logic algorithm is configured to determine if the price prediction is reasonable based on degrees of truth.

24. The method of claim 16, wherein the fuzzy logic algorithm is further configured to determine if the price prediction is reasonable based on a length of time before a departure date of the flight.

25. The method of claim 16, wherein the fuzzy logic algorithm is further configured to determine if the price prediction is reasonable based on competitor's prices.

26. The method of claim 16, wherein the fuzzy logic algorithm is further configured to determine if the price prediction is reasonable based on weather predictions or current weather.

27. The method of claim 16, wherein the fuzzy logic algorithm is further configured to determine if the price prediction is reasonable based on a flight cancellations.

28. The method of claim 16, wherein the fuzzy logic algorithm is further configured to determine if the price prediction is reasonable based on market competition.

29. The method of claim 16, wherein the fuzzy logic algorithm is further configured to determine if the price prediction is reasonable based on aircraft and crew availability.

30. The method of claim 16, wherein the fuzzy logic algorithm is further configured to determine if the price prediction is reasonable based on customer loyalty.
